(19) United States
(12) Patent Application Publication
(10) Pub. No.: US 2009/0307912 A1
(43) Pub. Date: Dec. 17, 2009

(54) Folding Ladle Device

(76) Inventors: Dean Chapman, Montclair, NJ (US); Paul Goetz, Astoria, NY (US); Gareth Brown, Jersey City, NJ (US); Ed Kilduff, New York, NY (US)

Correspondence Address: WHITE-WELKER & WELKER, LLC, P.O. BOX 199, CLEAR SPRING, MD, 21722-0199, US

(21) Appl. No.: 12/484,241

(22) Filed: Jun. 14, 2009

Related U.S. Application Data
(60) Provisional application No. 61/061,638, filed on Jun. 15, 2008.

(51) Int. Cl. A47J 43/28

(52) U.S. Cl. 30/327

(57) ABSTRACT

The folding ladle's primary function is similar to many other ladles found in the market today and known in the prior art, it can be used to scoop a standard size portion of liquid or powered solids from one container to another. The primary innovation of the invention is the flexible bowl, which allows the large scooping bowl of the ladle to fold in half for more compact storage. Once folded the ladle will hold this smaller position indefinitely until it is snapped back to its open position. This is achieved through the special shape of the ladle's bowl. When snapped into the closed position the size of the tool is greatly reduced in size and it fits more easily into drawers for storage.

### CROSS REFERENCE TO RELATED APPLICATIONS

This application claims priority from U.S. Provisional Patent Application Ser. No. 61/061,638, entitled “Folding Ladle Device”, filed on 15 Jun. 2008. The benefit under 35 USC §119(e) of the United States provisional application is hereby claimed, and the aforementioned application is hereby incorporated herein by reference.

This application is related to and claims priority from U.S. patent application Ser. No. 12/418,566, entitled “Storage Container with Collapsible Lid and Utensil”, filed on 3 Apr. 2009. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to cooking and kitchen devices. More specifically, the present invention relates to a cooking and kitchen device for scooping a standard size portion of liquid or powered solids from one container to another.

### BACKGROUND OF THE INVENTION

The problem with most ladles of this nature found on the market now and known in the prior art is that they are bulky and difficult to store. To that end, the present invention describes a folding ladle which folds flat for easy storage.

### SUMMARY OF THE INVENTION

The folding ladle's primary function is similar to many other ladles found in the market today and known in the prior art, it can be used to scoop a standard size portion of liquid or powered solids from one container to another. The primary innovation of the invention is the flexible bowl, which allows the large scooping bowl of the ladle to fold in half for more compact storage. Once folded the ladle will hold this smaller position indefinitely until it is snapped back to its open position. This is achieved through the special shape of the ladle's bowl combined with the use of a flexible material that can easily be deformed repeatedly

Therefore is it an objective of the present invention to teach a ladle which folds flat for easy storage.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a first orthogonal view of the device of the present invention in a first position where the bowl is in an extended position;

FIG. 2 is a second orthogonal view of the device of the present invention in a first position where the bowl is in an extended position;

FIG. 3 is a first perspective view of the device of the present invention in a first position where the bowl is in an extended position;

FIG. 4 is a second perspective view of the device of the present invention in a first position where the bowl is in an extended position; and

FIG. 5 is an expanded perspective view of the device of the present invention illustrating the components individually.

### DETAILED DESCRIPTION OF THE INVENTION

In the following detailed description of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

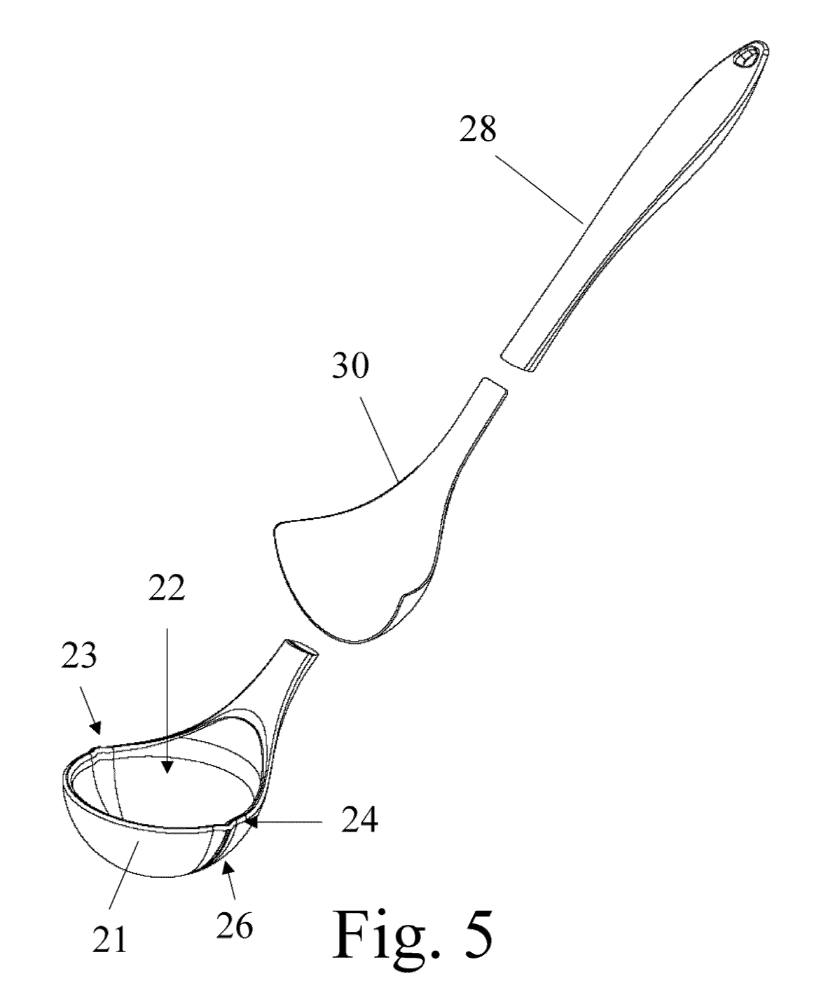

Referring to the figures, it is possible to see the various major elements constituting the apparatus of the present invention. Referring to FIG. 5, the embodiment of the folding ladle device is illustrated. The folding ladle 20 is composed of: a handle 28 made from plastic or other suitable material; an inner support piece 30 made of metal or other similar stiff material; and a flexible bowl 21 molded around the inner support, made of silicone or other similarly flexible material.

Now referring to Figures, an embodiment of the folding ladle is illustrated. The folding ladle's primary function is similar to many other ladles found in the market today, it can be used to scoop a standard size portion of liquid or powered solids from one storage container to another. The flexible scoop 21 allows the large scooping scoop of the ladle 20 to fold in half for more compact storage. Once folded, the ladle 20 will hold this smaller position indefinitely until it is snapped back to its open position. This is achieved through the special shape of the ladle's scoop 21.

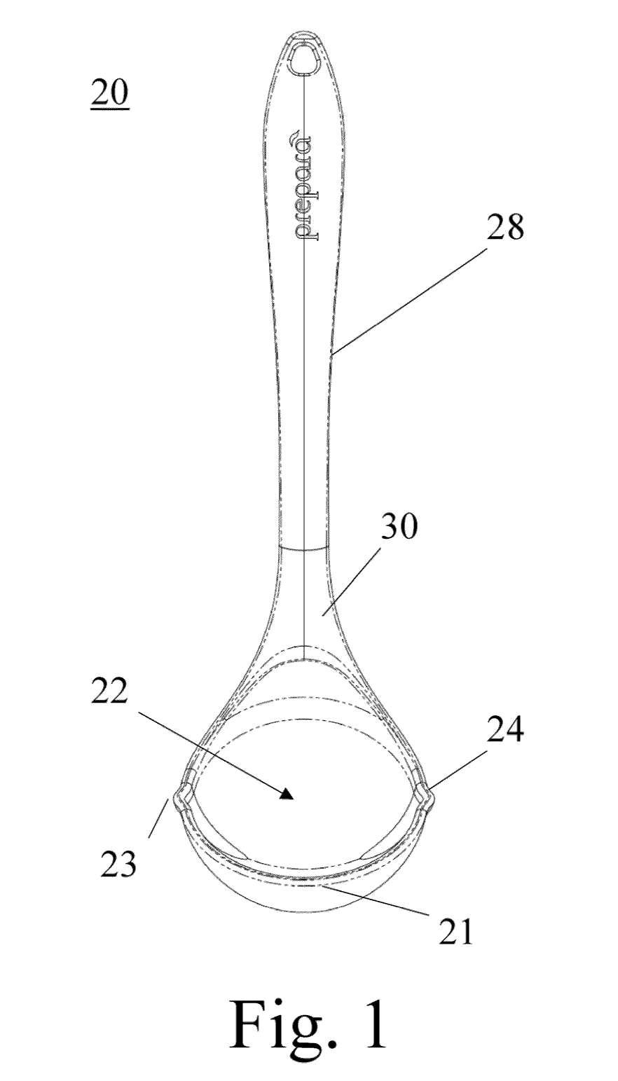

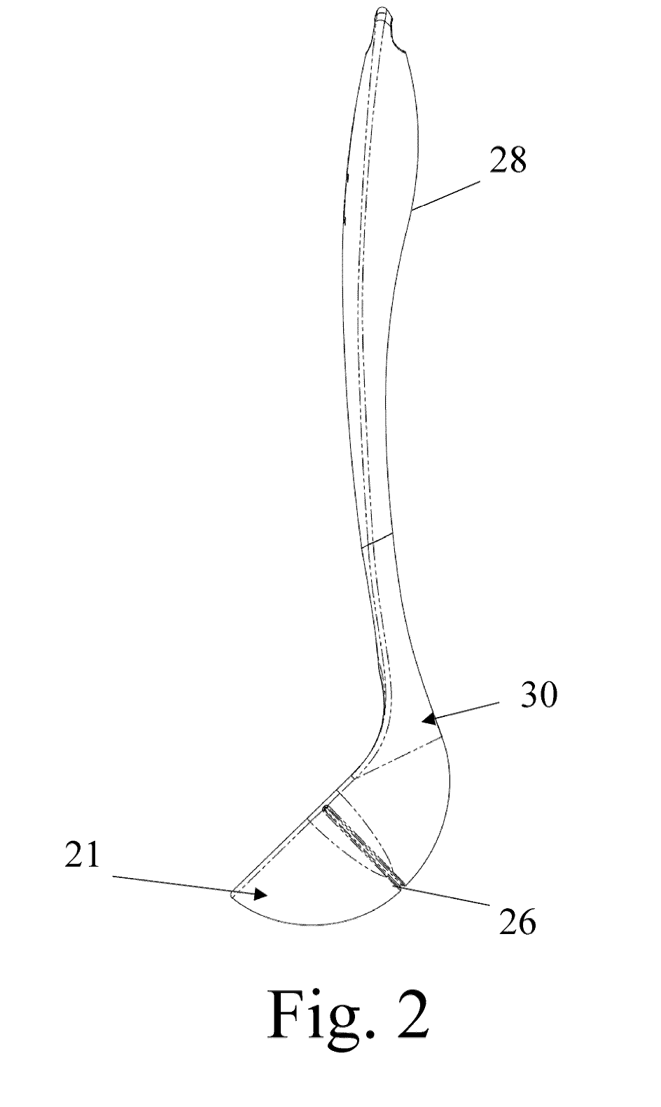

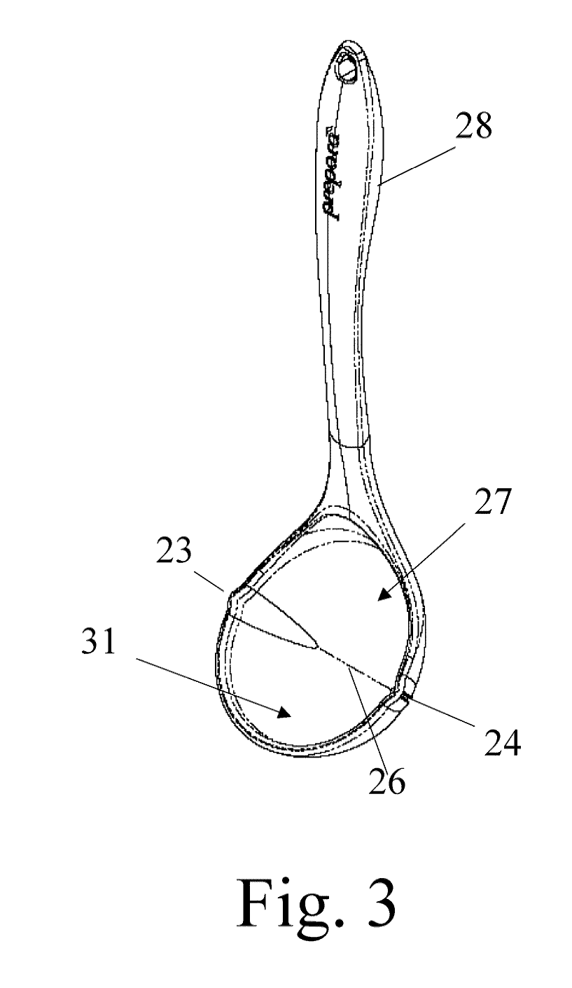

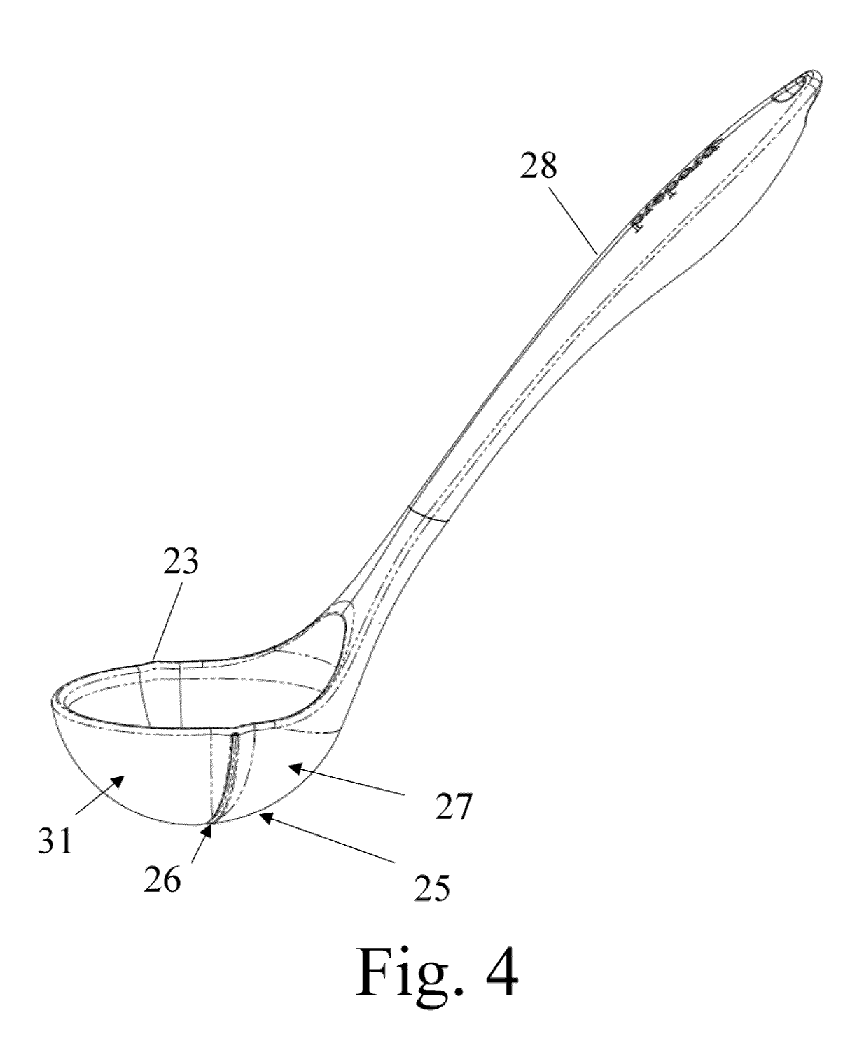

Referring to FIGS. 1-4, the scoop 21 is shaped with a concave top that forms a scooping area 22. This area 22 is shaped such that there is a small pouring spout 23 and 24 at either side. The bottom of the scoop 25 forms a convex surface offset from the inner surface. Along the apex of the convex surface a recessed groove 26 is molded into the scoop 21. This recessed groove 26 thins the scoop material along the scoop's center.

Inside the flexible scoop 21 a support 20 made from a piece of strong inflexible material is shaped to support the rear half 27 of the flexible scoop. This support 30 also flows into the handle 28 and acts to connect the handle 28 and scoop 21 forming a functioning tool. The support 30 is molded so that inside the scoop its support extends to just short of the recess 26 in the flexible material.

Because of this support structure 30, when force is applied to the front edge of the flexible scoop 20, pushing the scoop back toward the handle 28, the front half of the scoop 31 will deform, and fold into the supported back half 27. Once the front edge of the scoop moves far enough past the center of the scoop (apex of the concave surface) the recess 26 in its outside face folds over and snaps the front half of the scoop 31 against, and inside the back half 27. Because of the recess 26 shape the scoop will not unfold until an opposite force is applied to move the front edge of the scoop back to its open position. When snapped into the closed position the size of the tool is greatly reduced in size and it fits more easily into drawers for storage.

In an alternative embodiment, the folding ladle is composed of: a handle made from plastic or other suitable material; an inner support piece formed with and made integral to the handle made from the same material as the handle; and a flexible bowl molded around the inner support, made of silicone or other similarly flexible material.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A folding ladle consisting of the following parts in combination:
a handle;
an inner support; and
a flexible bowl molded around the inner support.

2. The folding ladle of claim 1 wherein
the flexible bowl is shaped with a concave top that forms a scooping area;
the bottom of the bowl forms a convex surface offset from the inner surface;
along the apex of the convex surface a recessed groove is molded into the bowl; and
a recess thins the bowl material along the bowl's center.

3. The folding ladle of claim 1 wherein the flexible bowl is shaped such that there is a small pouring spout at either side.

4. The folding ladle of claim 2 wherein
inside the flexible bowl a piece of strong inflexible material is shaped to support the rear half of the flexible bowl;
said support also flows into the handle and acts to connect the handle and bowl forming a functioning tool; and
said support is molded so that inside the bowl its support extends to just short of the recess in the flexible material.

5. The folding ladle of claim 4 wherein
when force is applied to the front edge of the flexible bowl, pushing the bowl back toward the handle, the front half of the bowl will deform, and fold into the supported back half,
once the front edge of the bowl moves far enough past the center of the bowl, an apex of the concave surface, the recess in its outside face folds over and snaps the front half of the bowl against, and inside the back half.

6. The folding ladle of claim 5 wherein, because of the recess shape, the bowl will not unfold until an opposite force is applied to move the front edge of the bowl back to its open position.

7. The folding ladle of claim 1 wherein, inner support piece is formed with and made integral to the handle in one piece.

8. The folding ladle of claim 1 wherein, the handle and inner support piece are made form the same material.
